(19) United States
(12) Patent Application Publication
(10) Pub. No.: US 2026/0094767 A1
(43) Pub. Date: Apr. 2, 2026

(54) MULTILAYER ELECTRONIC COMPONENT

(71) Applicant: SAMSUNG ELECTRO-MECHANICS CO., LTD., Suwon-si (KR)

(72) Inventors: Seung Hun KANG, Suwon-si (KR); Jae Hoon JI, Suwon-si (KR); Do Hoon KIM, Suwon-si (KR); Eun Young LEE, Suwon-si (KR); Kyung Ryul LEE, Suwon-si (KR); Bum Soo KIM, Suwon-si (KR)

(73) Assignee: SAMSUNG ELECTRO-MECHANICS CO., LTD., Suwon-si (KR)

(21) Appl. No.: 19/214,693

(22) Filed: May 21, 2025

(30) Foreign Application Priority Data
Sep. 30, 2024 (KR) 10-2024-0132608

(51) Int. Cl. H01G 4/12; H01G 4/30

(52) U.S. Cl. CPC H01G 4/1227; H01G 4/30

(57) ABSTRACT

A multilayer electronic component includes a body including a dielectric layer and internal electrodes; and external electrodes disposed on the body, wherein the dielectric layer includes a core not including a donor element and an acceptor element, and a core-shell dielectric grain having a shell structure covering at least a portion of the core and including the donor element, the acceptor element and titanium (Ti), and wherein, when an atomic percentage of the donor element included in the shell is defined as Ds and an atomic percentage of the acceptor element included in the shell is defined as As, based on an atomic percentage of 100 at % of titanium (Ti) included in the shell, 2 at %≤Ds≤13 at % and 1 at %≤As≤13 at % is satisfied.

### CROSS-REFERENCE TO RELATED APPLICATION(S)

This application claims benefit of priority to Korean Patent Application No. 10-2024-0132608 filed on Sep. 30, 2024 in the Korean Intellectual Property Office, the disclosure of which is incorporated herein by reference in its entirety.

### BACKGROUND

### 1. Technical Field

The present disclosure relates to a multilayer electronic component.

### 2. Description of Related Art

A multilayer ceramic capacitor (MLCC), a multilayer electronic component, may be a chip condenser mounted on the printed circuit boards of various electronic products including image display devices such as a liquid crystal display (LCD) and a plasma display panel (PDP), a computer, a smartphone, a mobile phone, or the like, charging or discharging electricity therein or therefrom.

Such a multilayer ceramic capacitor may be used as a component of various electronic devices, since a multilayer ceramic capacitor may have a small size and high capacitance and may be easily mounted. As various electronic devices such as a computer and a mobile device have been designed to have a smaller size and higher output, demand for miniaturization and increased capacitance of a multilayer ceramic capacitor has increased.

In response to this demand, the types/compositions of dielectric have been actively developed, and research on a material exhibiting high dielectric constant may also be actively conducted. Particularly, there has been research on implementing a high dielectric constant high dielectric constant by adding donor elements and acceptor elements to a dielectric and forming a defect-cluster, but defect-cluster-based high dielectric constant materials may have limitations such as high dielectric loss and low resistivity, such that commercialization may still be limited.

### SUMMARY

An embodiment of the present disclosure is to provide a multilayer electronic component having improved dielectric properties and improved resistivity properties.

According to an embodiment of the present disclosure, a multilayer electronic component includes a body including a dielectric layer and internal electrodes; and external electrodes disposed on the body, wherein the dielectric layer includes a core-shell dielectric grain including: a core that is free of a donor element and an acceptor element, and a shell covering at least a portion of the core and including the donor element, the acceptor element, and titanium (Ti), and wherein, when an atomic percentage of the donor element included in the shell is defined as Ds and an atomic percentage of the acceptor element included in the shell is defined as As, based on an atomic percentage of 100 at % of titanium (Ti) included in the shell, 2 at %≤Ds≤13 at % and 1 at %≤As ≤13 at % are satisfied.

According to an embodiment of the present disclosure, a multilayer electronic component includes a body including a dielectric layer including titanium (Ti), and internal electrodes; and external electrodes disposed on the body, wherein the dielectric layer includes a core-shell dielectric grain including: a core that is free of a donor element and an acceptor element, and a shell covering at least a portion of the core and including the donor element, and the acceptor element, and wherein, when a number of moles of the donor element based on 100 moles of titanium (Ti) included in the dielectric layer is defined as Dm, and a number of moles of the acceptor element based on 100 moles of titanium (Ti) included in the dielectric layer is defined as Am, 0.5 moles≤Dm≤4 moles and 0.25 moles≤Am≤4 moles are satisfied.

### BRIEF DESCRIPTION OF DRAWINGS

The and other aspects, features, and advantages of the present disclosure will be more clearly understood from the following detailed description, taken in combination with the accompanying drawings, in which:

FIG. 1 is a perspective diagram illustrating a multilayer electronic component according to an embodiment of the present disclosure;

FIG. 2 is an exploded perspective diagram illustrating a lamination structure of an internal electrode according to an embodiment of the present disclosure;

FIG. 3 is a cross-sectional diagram taken along line I-I′ in FIG. 1;

FIG. 4 is a cross-sectional diagram taken along line II-II′ in FIG. 1;

FIG. 5 is a cross-sectional diagram taken along line II-II′ in FIG. 1 according to another embodiment of the present disclosure;

FIG. 6 is an enlarged diagram illustrating region P illustrated in FIG. 3; and

FIGS. 7A to 7E are images obtained by mapping various elements with respect to a cross-section of a dielectric layer using TEM-EDS according to an embodiment of the present disclosure.

### DETAILED DESCRIPTION

Hereinafter, embodiments of the present disclosure will be described as below with reference to the accompanying drawings.

These embodiments are described in sufficient detail to enable those skilled in the art to practice the invention. It is to be understood that the various embodiments of the invention, although different, are not necessarily mutually exclusive. For example, structures, shapes, and sizes described as examples in embodiments in the present disclosure may be implemented in another embodiment without departing from the spirit and scope of the present disclosure. Further, modifications of positions or arrangements of elements in embodiments may be made without departing from the spirit and scope of the present disclosure. The following detailed description is, accordingly, not to be taken in a limiting sense, and the scope of the present disclosure are defined only by appended claims, appropriately interpreted, along with the full range of equivalents to which the claims are entitled.

In the drawings, same elements will be indicated by same reference numerals. Also, redundant descriptions and detailed descriptions of known functions and elements which may unnecessarily render the gist of the present disclosure obscure will be omitted. In the accompanying drawings, some elements may be exaggerated, omitted or briefly illustrated, and the sizes of the elements do not necessarily reflect the actual sizes of these elements. The terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof.

In the drawings, the first direction may be defined as a lamination direction or a thickness (T) direction, the second direction may be defined as a length (L) direction, and the third direction may be defined as a width (W) direction.

### Multilayer Electronic Component

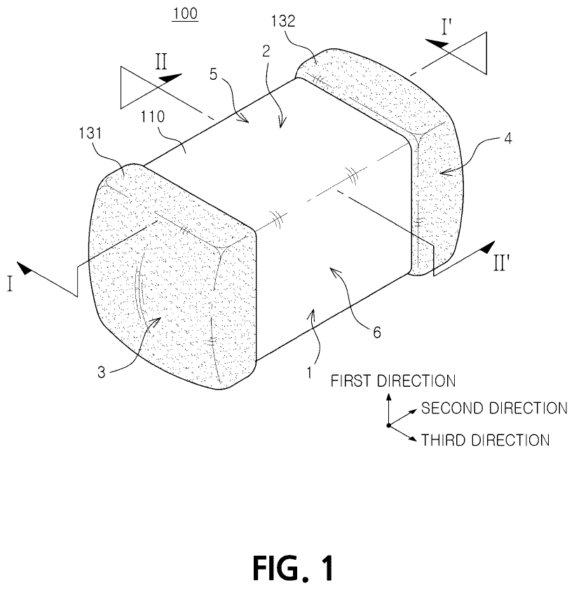

FIG. 1 is a perspective diagram illustrating a multilayer electronic component according to an embodiment.

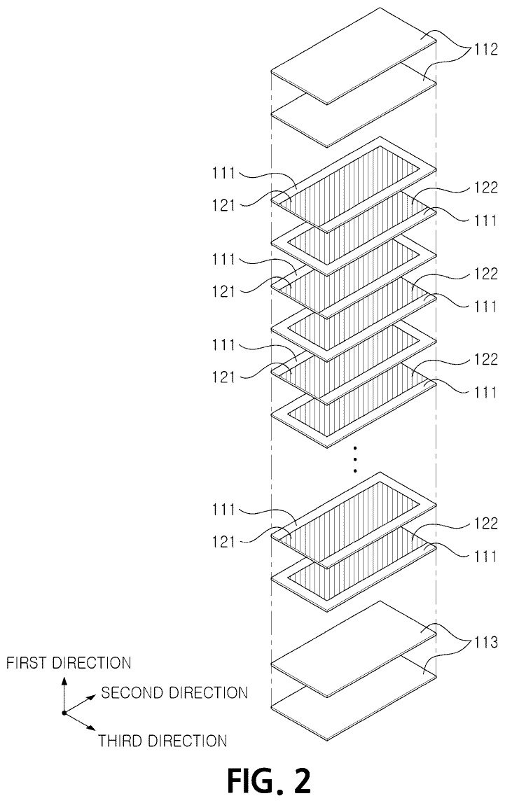

FIG. 2 is an exploded perspective diagram illustrating a lamination structure of an internal electrode according to an embodiment.

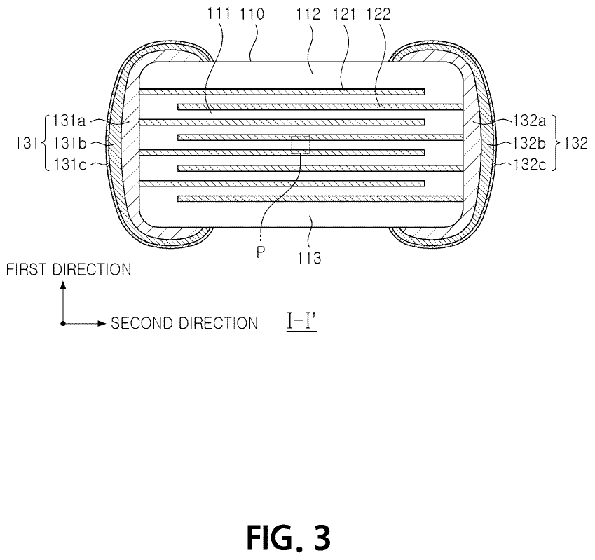

FIG. 3 is a cross-sectional diagram taken along line I-I′ in FIG. 1.

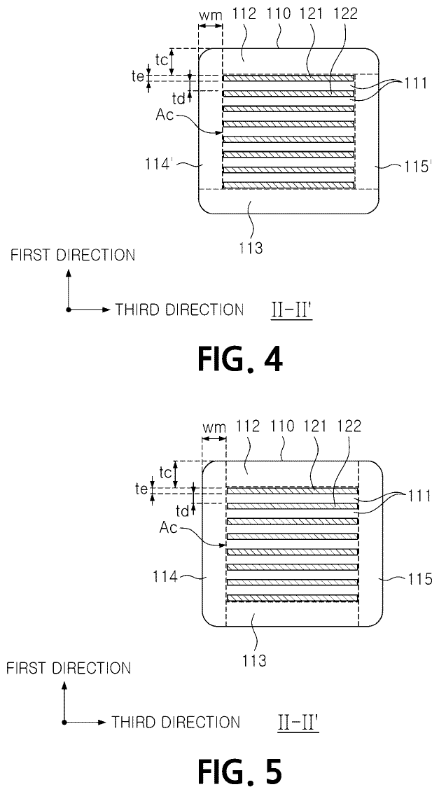

FIG. 4 is a cross-sectional diagram taken along line II-II′ in FIG. 1.

FIG. 5 is a cross-sectional diagram taken along line II-II′ in FIG. 1 according to another embodiment.

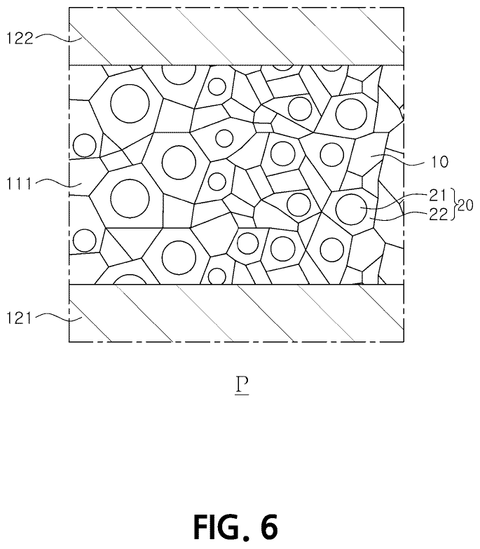

FIG. 6 is an enlarged diagram illustrating region P illustrated in FIG. 3.

Hereinafter, a multilayer electronic component according to an embodiment will be described in greater detail with reference to FIGS. 1 to 6. A multilayer ceramic capacitor will be described as an example of a multilayer electronic component, but an embodiment thereof is not limited thereto, and the multilayer ceramic capacitor may be applied to various multilayer electronic components, such as an inductor, a piezoelectric element, a varistor, or a thermistor.

A multilayer electronic component 100 according to an embodiment may include a body 110 including a dielectric layer 111 and internal electrodes 121 and 122; and external electrodes 131 and 132 disposed on the body, wherein the dielectric layer 111 includes a core 21 not including a donor element and an acceptor element, and a core-shell dielectric grain 20 having a shell structure covering at least a portion of the core 21 and including the donor element, the acceptor element and titanium (Ti), and wherein, when an atomic percentage of the donor element included in the shell 22 is defined as Ds and an atomic percentage of the acceptor element included in the shell 22 is defined as As based on an atomic percentage of 100 at % of titanium (Ti) included in the shell, 2 at %≤Ds≤13 at % and 1 at %≤As≤13 at % is satisfied.

A multilayer electronic component 100 according to another embodiment may include a body including a dielectric layer 111 including titanium (Ti), and internal electrodes 121 and 122; and external electrodes 131 and 132 disposed on the body 110, wherein the dielectric layer 111 includes a core 21 not including a donor element and an acceptor element, and a core-shell dielectric grain 22 of a shell structure covering at least a portion of the core 21 and including the donor element and the acceptor element, and wherein, when the number of moles of the donor element based on 100 parts by mole of titanium (Ti) included in the dielectric layer 111 is defined as Dm, and the number of moles of the acceptor element based on 100 parts by mole of titanium (Ti) included in the dielectric layer is defined as Am, 0.5 part by mole≤Dm≤4 parts by mole and 0.25 part by mole≤Am≤4 parts by mole are satisfied.

In the body 110, the dielectric layers 111 and the internal electrodes 121 and 122 may be alternately laminated.

More specifically, the body 110 may include a capacitance forming portion Ac disposed in the body 110 and forming capacitance including the first internal electrode 121 and the second internal electrode 122 alternately disposed to face each other with the dielectric layer 111 interposed therebetween.

The shape of the body 110 may not be limited to any particular shape, but as illustrated, the body 110 may have a hexahedral shape or a shape similar to a hexahedral shape. Due to reduction of ceramic powder included in the body 110 during a firing process, the body 110 may not have an exactly hexahedral shape formed by linear lines but may have a substantially hexahedral shape.

The body 110 may have the first and second surfaces 1 and 2 opposing each other in the first direction, the third and fourth surfaces 3 and 4 connected to the first and second surfaces 1 and 2 and opposing in the second direction, and the fifth and sixth surfaces 5 and 6 connected to the first to fourth surfaces 1, 2, 3, and 4 and opposing each other in the third direction.

The plurality of dielectric layers 111 forming the body 110 may be in a fired state, and boundaries between the adjacent dielectric layers 111 may be integrated with each other such that the boundaries may not be distinct without using a scanning electron microscope (SEM).

The raw material forming the dielectric layer 111 is not limited as long as sufficient capacitance may be obtained therewith, and the raw material forming the dielectric layer 111 may refer to a main component of the dielectric layer 111.

For example, a barium titanate (BaTiO₃) material, a strontium titanate (SrTiO₃) material, a titanium dioxide (TiO₂) material, or the like, may be used. The barium titanate (BaTiO₃) material may include BaTiO₃-based ceramic particles, and examples of BaTiO₃-based ceramic particles may include BaTiO₃ and (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1) or Ba(Ti_{1-y}Zr_{y})O₃ (0<y<1) in which Ca(calcium), Zr(zirconium), or the like, are partially dissolved. A strontium titanate (SrTiO₃) material may include SrTiO₃ ceramic particles, and examples thereof may include SrTiO₃ and (Sr₁₋ₓCaₓ)TiO₃ (0<x<1), Sr(Ti_{1-y}Ca_{y})O₃ (0<y<1), (Sr₁₋ₓCaₓ) (Ti_{1-y}Zr_{y})O₃ (0<x<1, 0<y<1) or Sr(Ti_{1-y}Zr_{y})O₃ (0<y<1) in which Ca (calcium), Zr (zirconium), or the like, are partially dissolved in SrTiO₃.

In embodiments, the term “main component” may indicate a component occupying a relatively large weight ratio or atomic number ratio as compared to other components, and may indicate a component exceeding 50 wt % based on the weight of the entire composition or the entire dielectric layer, a component exceeding 50 at % based on the number of atoms, or a component exceeding 50 moles % based on the number of moles.

As an example of a more specific method of measuring the content of an element included in each configuration of the multilayer electronic component 100 in embodiments, the component may be analyzed using the energy dispersive X-ray spectroscopy (EDS) mode of a scanning electron microscope (SEM), the EDS mode of a transmission electron microscope (TEM), or the EDS mode of a scanning transmission electron microscope (STEM). First, a thinned analysis sample may be prepared using a focused ion beam (FIB) device in the region to be measured. Thereafter, the surface damage layer of the thinned sample may be removed using xenon (Xe) or argon (Ar) ion milling, and each component to be measured may be mapped from the image obtained using SEM-EDS, TEM-EDS, or STEM-EDS and a qualitative/quantitative analysis may be carried out. In this case, the qualitative/quantitative analysis graph of each component may be represented by converting the content of each element, for example, weight percentage (wt %), atomic percentage (at %), or moles percentage (mol %), and may also represent the content of another specific component for the content of a specific component.

As another method, by crushing a chip and selecting the region to be measured, the selected dielectric microstructure may be included in the region and specific components of the region may be analyzed using a device such as an inductively coupled plasma optical emission spectrometer (ICP-OES) or an inductively coupled plasma mass spectrometer (ICP-MS). Other methods and/or tools appreciated by one of ordinary skill in the art, even if not described in the present disclosure, may also be used.

Also, the raw material forming the dielectric layer 111 may be barium titanate (BaTiO₃) particles, or the like, to which various ceramic additives, organic solvents, binders, dispersants, or the like, may be added depending on the purpose of embodiments.

In order to distinguish the dielectric layer included in the cover portions 112 and 113 and side margin portions 114 and 115 described below, the dielectric layer included in the capacitance forming portion Ac may be defined as a first dielectric layer, the dielectric layer included in the cover portions 112 and 113 may be defined as a second dielectric layer, and the dielectric layer included in the side margin portions 114 and 115 may be defined as a third dielectric layer. However, unless otherwise indicated, the description of the: first dielectric layer 111 may be described as the dielectric layer 111.

Since the first to third dielectric layers may be formed using a dielectric material, after firing, the dielectric layers may include a dielectric microstructure. The dielectric microstructure may include a plurality of dielectric grains, a grain boundary disposed between adjacent dielectric grains, and an n-central point disposed at a point at which three or more of the grain boundaries meet, and may include a plurality of dielectric grains, grain boundaries, and n-central points.

The dielectric layer 111 may include a core-shell dielectric grain 20 having a core-shell structure. However, an embodiment thereof is not limited thereto, and the dielectric layer 111 may include a dielectric grain 10 not having a core-shell structure.

The core-shell dielectric grain 20 may include a core 21 not including a donor element and an acceptor element, and a shell 22 structure covering at least a portion of the core 21 and including the donor element, the acceptor element and titanium (Ti).

Here, the donor element may indicate a group 5 element, and may include, for example, at least one of niobium (Nb), tantalum (Ta) and vanadium (V), preferably at least one of niobium (Nb) and tantalum (Ta), more preferably niobium (Nb).

The acceptor element may indicate a group 2 element, a group 3 element, a group 13 element, or a lanthanide element, and may include, for example, at least one of aluminum (Al), gallium (Ga), magnesium (Mg), zinc (Zn), scandium (Sc), indium (In), ytterbium (Yb), erbium (Er), and europium (Eu), preferably at least one of magnesium (Mg) and indium (In), more preferably magnesium (Mg).

The types of the donor element and the acceptor element may indicate elements included in the dielectric layer and acting as a donor and an acceptor, respectively, but an embodiment thereof is not limited thereto

The donor element and the acceptor element may need to be included in the dielectric at an appropriate concentration to exhibit excellent dielectric properties, and the size of the element to be included at an appropriate concentration may be 70 μm or more, 85 μm or less based on the ionic radius for the donor element, and 66 μm or more, 110 μm or less based on the ionic radius for the acceptor element.

Also, when at least one of barium titanate (BaTiO₃) and strontium titanate (SrTiO₃) is used as the main component raw material of the dielectric layer 111, the core 21 and the shell 22 may include elements of the main component raw material, for example, barium (Ba), strontium (Sr), and titanium (Ti).

More specifically, in the core-shell dielectric grain 20, the core 21 may not include (may be free of) the donor element and the acceptor element.

Here, the notion that the core 21 does not include (is free of) the donor element and the acceptor element may indicate that the donor element and the acceptor element are not detected when EDS analysis is performed. However, an embodiment thereof is not limited thereto, and the example may include the case when the atomic percentages of the donor element and the acceptor element are each less than 1.0 at %, more preferably less than 0.6 at %, based on an atomic percentage of 100 at % of titanium (Ti) included in the core 21.

In this case, the atomic percentage (at %) of the elements included in core 21 may be obtained by performing EDS analysis on 4 points in the core 21 region and averaging the atomic percentage (at %) of each element at the 4 points, but an embodiment thereof is not limited thereto. Other methods and/or tools appreciated by one of ordinary skill in the art, even if not described in the present disclosure, may also be used.

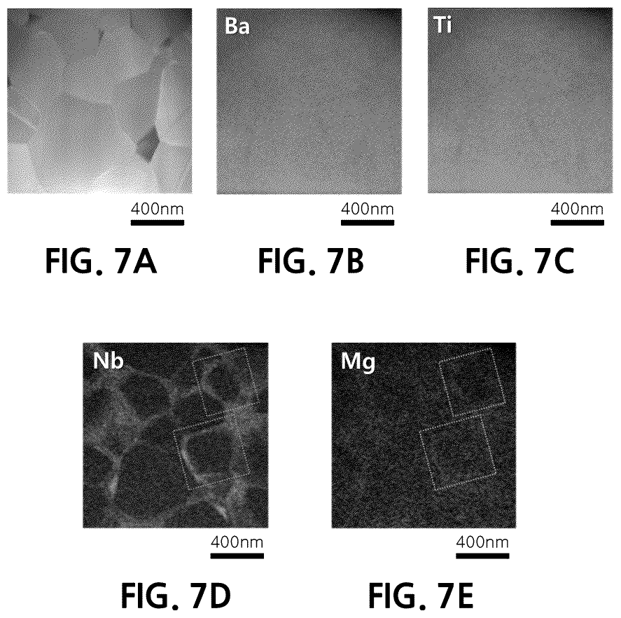

To describe more specifically with reference to FIGS. 7A to 7E, FIG. 7A is an image of a cross-section of the entire layer 111 imaged by TEM, FIG. 7B is an image of barium (Ba) mapped by EDS analysis in the same region, FIG. 7C is an image of titanium (Ti) mapped by EDS analysis in the same region, FIG. 7D is an image of niobium (Nb) mapped by EDS analysis in the same region, and FIG. 7E is an image of magnesium (Mg) mapped by EDS analysis in the same region.

Referring to FIG. 7D, it may be interpreted that the region from which niobium (Nb) is not detected may be the core 21 and the region from which niobium (Nb) is detected may be the shell 22. Referring to FIG. 7E, it may be interpreted that the region from which magnesium (Mg) is not detected is the core 21 and the region from which magnesium (Mg) is detected is the shell 22. Even when niobium (Nb) or magnesium (Mg) elements are mapped by EDS analysis, it may not be easy to distinguish the regions of the core 21 and the shell 22 due to noise. In this case, the core 21 and the shell 22 may be distinguished based on the atomic percentage (at %) value described above through qualitative/quantitative point analysis.

More specifically, one of the core-shell dielectric grains 20 in FIGS. 7A to 7E was selected, and TEM-EDS analysis was performed on 4 points of the corresponding core 21. When the average value of the element percentage (at %) of niobium (Nb) and magnesium (Mg) in the detected 4 points was calculated, niobium (Nb) was 0.59 at % and magnesium (Mg) element was 0.58 at %.

The shell 22 may include a donor element, an acceptor element and titanium (Ti).

Here, the notion that shell 22 includes a donor element and an acceptor element may indicate that at least one of the donor element and the acceptor element is substituted for at least one of the element sites of shell 22 other than the oxygen element (0) among the main components.

More specifically, for example, the donor element may be substituted for the titanium (Ti) element site in barium titanate (BaTiO₃) and strontium titanate (SrTiO₃). The acceptor element may be substituted for both the barium (Ba) element site and the titanium (Ti) element site (preferably the titanium (Ti) element site) in the case of barium titanate (BaTiO₃), and may be substituted for both the strontium (Sr) element site and the titanium (Ti) element site (preferably the titanium (Ti) element site) in the case of strontium titanate (SrTiO₃). The element that is being substituted for may be determined by X-ray diffraction. Other methods and/or tools appreciated by one of ordinary skill in the art, even if not described in the present disclosure, may also be used.

In this case, based on the atomic percentage of titanium (Ti) included in the shell 22 of 100 at %, when the atomic percentage of the donor element included in the shell 22 is defined as Ds and the atomic percentage of the acceptor element included in the shell 22 is defined as As, 2 at %≤Ds≤13 at % and 1 at %≤As≤13 at % may be satisfied.

Since shell 22 satisfies 2 at %≤Ds≤13 at % and 1 at %≤As≤13 at %, the dissipation factor DF may be 10.0% or less, the dielectric constant may be 7×10³ or more, and resistivity (Ω cm) may be 10¹⁰ Ωcm or more.

In this case, the atomic percentage (at %) of elements included in the shell 22 may be obtained by performing EDS analysis on 8 points in the shell 22 region and averaging the atomic percentage (at %) of each element at the 8 points, but an embodiment thereof is not limited thereto.

For example, one of the core-shell dielectric grains 20 in FIGS. 7A to 7E was selected, and TEM-EDS analysis was performed on 8 points of the corresponding shell 22. When the average value of the element percentage (at %) of niobium (Nb) and magnesium (Mg) at the 8 detected points was obtained, niobium (Nb) was 6.63 at % and magnesium (Mg) was 3.23 at %.

When Ds is less than 2 at %, resistivity properties may be excellent and dielectric loss may be low, but the dielectric constant may not be excellent, and when Ds is more than 13 at %, the dielectric constant may be excellent and the dissipation factor DF may be low, but resistivity properties may not be excellent.

Also, when As is less than 1 at %, the dielectric constant may be excellent and the dissipation factor DF may be low, but resistivity properties may not be excellent, and when As is more than 13 at %, the dielectric constant may be excellent but resistivity may not be excellent.

When the core 21 and the shell 22 do not include the donor element and the acceptor element, the dissipation factor DF may be low and resistivity properties may be excellent, but the dielectric constant may not be excellent.

Also, when the core 21 and the shell 22 include the donor element and the acceptor element, the dielectric constant may be excellent and the dissipation factor DF may be low, but resistivity properties may not be excellent.

In an embodiment, Ds and As of the shell 22 may satisfy As ≤Ds, and more preferably As≤Ds≤3×As. In other words, the ratio of the atomic percentage (Ds) of the donor element to 100 at % titanium (Ti) included in the shell 22 and the atomic percentage (As) of the acceptor element to 100 at % titanium (Ti) included in the shell 22 (Ds:As) may satisfy 1:1 to 3:1.

Since the atomic percentage (at %) of the donor element and the acceptor element satisfies As≤Ds, the dissipation factor DF may be low and the dielectric constant and resistivity properties may be excellent.

When the atomic percentage (at %) of the donor element and the acceptor element is defined as Ds<As, the dielectric constant may not be excellent.

When the number of moles of the donor element based on 100 moles (100 parts by mole) of titanium (Ti) included in the dielectric layer 111 is defined as Dm, and the number of moles of the acceptor element based on 100 moles (100 parts by mole) of titanium (Ti) included in the dielectric layer 111 is defined as Am, 0.5 moles≤Dm≤4 moles and 0.25 moles≤Am≤4 moles may be satisfied. In some embodiments, 0.5 part by mole≤Dm≤4 parts by mole and 0.25 part by mole≤Am≤4 parts by mole may be satisfied.

Since the dielectric layer 111 satisfies 0.5 moles≤Dm≤4 moles and 0.25 moles≤Am≤4 moles, or 0.5 part by mole≤Dm≤4 parts by mole and 0.25 part by mole≤Am≤4 parts by mole, the dissipation factor DF may be low and the dielectric constant and resistivity properties may be excellent.

When Dm is less than 0.5 moles (or 0.5 part by mole), resistivity properties may be excellent and dielectric loss may be low, but the dielectric constant may not be excellent, and when Dm is more than 4 moles (or 4 parts by mole), the dielectric constant may be excellent and the dissipation factor DF may be low, but resistivity properties may not be excellent.

Also, when Am is less than 0.25 moles (or 0.5 part by mole), the dielectric constant may be excellent and the dissipation factor DF may be low, but resistivity properties may not be excellent, and when Am is more than 4 moles (or 4 parts by mole), the dielectric constant may be excellent but resistivity may not be excellent.

In an embodiment, Dm and Am may satisfy Am≤Dm, and more preferably, may satisfy Am≤Dm≤3×Am. In other words, the ratio of the number of moles (Dm) of the donor element to 100 moles (100 parts by mole) of titanium (Ti) included in the dielectric layer 111 and the number of moles (Am) of the acceptor element to 100 moles (100 parts by mole) of titanium (Ti) included in the dielectric layer 111 (Dm:Am) may satisfy 1:1 to 3:1.

Since the number of moles of the donor element and the acceptor element satisfy Am≤Dm, the dissipation factor DF may be small, and the dielectric constant and resistivity properties may be excellent.

When the number of moles of the donor element and the acceptor element is defined as Dm<Am, the dielectric constant may not be excellent.

A thickness td of the dielectric layer 111 may not be limited to any particular example.

In order to assure reliability of the multilayer electronic component 100 under a high-voltage environment, the thickness td of the dielectric layer may be 10.0 μm or less. Also, in order to implement miniaturization and high capacitance of the multilayer electronic component 100, the thickness td of the dielectric layer may be 3.0 μm or less. In order to implement ultra-miniaturization and high capacitance more easily, the thickness td of the dielectric layer may be 1.0 μm or less, preferably 0.6 μm or less, and more preferably 0.4 μm or less.

In this case, the thickness td of the dielectric layer may include the thickness of at least one of a plurality of dielectric layers, or may include the thickness of the entirety of the dielectric layers.

Here, the thickness td of the dielectric layer may indicate the thickness td of the dielectric layer disposed between the first and second internal electrodes 121 and 122.

The thickness td of the dielectric layer may indicate the size of the dielectric layer 111 in the first direction.

Also, the thickness td of the dielectric layer may indicate the average thickness td of one dielectric layer, or may indicate the average thickness td of a plurality of dielectric layers.

The average size, in the first direction, of the dielectric layer 111 may be measured by scanning a cross-section in the first and second directions of the body 110 using a scanning electron microscope (SEM) with a magnification of 10,000. More specifically, the average size, in the first direction, of the dielectric layer 111 may indicate the average value calculated by measuring the sizes, in the first direction, of the dielectric layer 111 at 10 points at an equal distance in the second direction in the scanned image. The 10 points at an equal distance may be specified in the capacitance formation portion Ac. Also, by extending the measurement of the average value to 10 dielectric layers 111, the average size, in the first direction, of the dielectric layer 111 may be further generalized.

The internal electrodes 121 and 122 may be laminated alternately with the dielectric layer 111.

The internal electrodes 121 and 122 may include a first internal electrode 121 and a second internal electrode 122, the first and second internal electrodes 121 and 122 may be alternately disposed to face each other with the dielectric layer 111 included in the body 110 interposed therebetween, and may be exposed to the third and fourth surfaces 3 and 4 of the body 110, respectively.

More specifically, the first internal electrode 121 may be spaced apart from the fourth surface 4 and may be exposed through the third surface 3, and the second internal electrode 122 may be spaced apart from the third surface 3 and may be exposed through the fourth surface 4. The first external electrode 131 may be disposed on the third surface 3 of the body 110 and may be connected to the first internal electrode 121, and the second external electrode 132 may be disposed on the fourth surface 4 of the body 110 and may be connected to the second internal electrode 122.

That is, the first internal electrode 121 may not be connected to the second external electrode 132 and may be connected to the first external electrode 131, and the second internal electrode 122 may not be connected to the first external electrode 131 and may be connected to the second external electrode 132. In this case, the first and second internal electrodes 121 and 122 may be electrically separated from each other by the dielectric layer 111 disposed therebetween.

The body 110 may be formed by alternately laminating ceramic green sheets on which the first internal electrodes 121 are printed and ceramic green sheets on which the second internal electrodes 122 are printed, and firing the sheets.

The material for forming the internal electrodes 121 and 122 is not limited to any particular example, and a material having excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti), and alloys thereof.

Also, the internal electrodes 121 and 122 may be formed by printing conductive paste for internal electrodes including one or more of nickel (Ni), copper (Cu), palladium (Pd), silver (Ag), gold (Au), platinum (Pt), tin (Sn), tungsten (W), titanium (Ti), and alloys thereof on a ceramic green sheet. A screen printing method or a gravure printing method may be used as a method of printing the conductive paste for internal electrodes, but an embodiment thereof is not limited thereto.

The thickness the of the internal electrodes 121 and 122 may not be limited to any particular example.

In order to assure reliability under a high-voltage environment of the multilayer electronic component 100, the thickness the of the internal electrode may be 3.0 μm or less. Also, in order to implement miniaturization and high capacitance of the multilayer electronic component 100, the thickness the of the internal electrode may be 1.0 μm or less. In order to more easily implement ultra-miniaturization and high capacitance, the thickness the of the internal electrode may be 0.6 μm or less, and more preferably, 0.4 μm or less.

In this case, the thickness the of the internal electrode may include at least one thickness the of a plurality of internal electrodes, or may include the thickness the of the entirety of internal electrodes.

Here, the thickness the of the internal electrode may indicate the size in the first direction of the internal electrodes 121 and 122.

Also, the thickness the of the internal electrode may indicate the average thickness the of one internal electrode, or may indicate the average thickness the of a plurality of internal electrodes.

The average size, in the first direction, of the internal electrodes 121 and 122 may be measured by scanning a cross-section of the body 110 using a scanning electron microscope (SEM) with a magnification of 10,000×. More specifically, an average value may be measured from the sizes, in the first direction, of the internal electrode at 10 points at an equal distance in the second direction in the scanned image. The 10 points at an equal distance may be designated in the capacitance formation portion Ac. Also, by extending the measurement of the average value to 10 internal electrodes, the average size of the internal electrodes 121 and 122 may be further generalized.

In an embodiment, the thickness td of at least one of the plurality of dielectric layers and the thickness the of at least one of the plurality of internal electrodes may satisfy 2×te<td.

In other words, the thickness td of one of the dielectric layers may be greater than twice the thickness the of one of the internal electrodes. Preferably, the average thickness td of the plurality of dielectric layers may be greater than twice the average thickness the of the plurality of internal electrodes.

Generally, a reliability issue due to a decrease in the breakdown voltage (BDV) under a high-voltage environment may be a major issue for high-voltage electronic components.

In order to prevent a decrease in breakdown voltage under a high-voltage environment, by configuring the average thickness td of the dielectric layer to be greater than twice the average thickness the of the internal electrode, the thickness of the dielectric layer, which is the distance between the internal electrodes, may be increased, and breakdown voltage properties may be improved.

When the average thickness td of the dielectric layer is less than twice the average thickness the of the internal electrodes, the average thickness of the dielectric layer, which is the distance between the internal electrodes, may be reduced, such that the breakdown voltage may be decrease and a short may occur between the internal electrodes.

The body 110 may include cover portions 112 and 113 disposed on both end-surfaces of the capacitance forming portion Ac in the first direction.

Specifically, the body 110 may include a first cover portion 112 disposed on one surface in the first direction of the capacitance formation portion Ac and a second cover portion 113 disposed on the other surface in the first direction of the capacitance formation portion Ac. More specifically, the body 110 may include the upper cover portion 112 disposed in the upper portion in the first direction of the capacitance formation portion Ac and the lower cover portions 113 disposed in the lower portion in the first direction of the capacitance formation portion Ac.

The first cover portion 112 and the second cover portion 113 may be formed by laminating a single dielectric layer 111 or two or more dielectric layers 111 on the upper and lower surfaces of the capacitance forming portion Ac in the first direction, and may prevent damages to the internal electrodes 121 and 122 due to physical or chemical stress.

The first cover portion 112 and the second cover portion 113 may not include the internal electrodes 121 and 122 and may include the same material as that of the dielectric layer 111. That is, the upper cover portion 112 and the lower cover portion 113 may include a ceramic material, for example, a barium titanate (BaTiO₃) ceramic material.

The thickness tc of the cover portion 112 and 113 may not be limited to any particular example.

However, to easily implement miniaturization and high capacitance of multilayer electronic component, the thickness tc of the cover portions 112 and 113 may be 100 μm or less, preferably 30 μm or less. More preferably, the thickness may be 20 μm or less in an ultra-small product.

Here, the thickness tc of the cover portion may indicate the size in the first direction of the cover portions 112 and 113.

Also, the thickness tc of the cover portion may indicate the average thickness tc of each of the first and second cover portions 112 and 113, or may indicate the average thickness tc of the first and second cover portions 112 and 113.

The average size of the cover portions 112 and 113 may be measured by scanning a cross-section in the first and second directions of the body 110 using a scanning electron microscope (SEM) at a magnification of 10,000. More specifically, the average size may indicate the average value calculated by measuring the sizes, in the first direction, at 10 points at an equal distance in the second direction in the scanned image of the cover portion.

Also, the average size, in the first direction, of the cover portion measured by the above method may be substantially the same as the average size, in the first direction, of the cover portion in the cross-section in the first and third directions of the body 110.

The multilayer electronic component 100 may include side margin regions 114′ and 115′ in the region in the third direction of the internal electrodes 121 and 122.

More specifically, the side margin regions 114′ and 115′ may include a first side margin region 114′ disposed between the internal electrodes 121 and 122 and the fifth surface 5 and a second side margin region 115′ disposed between the internal electrodes 121 and 122 and the sixth surface 6.

The side margin regions 114′ and 115′ may indicate a region between both end-surfaces of the first and second internal electrodes 121 and 122 in the third direction and a boundary surface of the body 110 with respect to the cross-section in the first and third direction of the body 110, as illustrated.

The side margin regions 114′ and 115′ may indicate a ceramic green sheet region other than the internal electrodes 121 and 122 when the paste for the internal electrode is applied to the ceramic green sheet applied to the capacitance forming portion Ac, except for the region in which the side margin regions 114′ and 115′ are formed.

The side margin regions 114′ and 115′ may basically prevent damages to the internal electrodes 121 and 122 due to physical or chemical stress.

The first side margin region 114′ and the second side margin region 115′ may not include the internal electrodes 121 and 122, and may include the same material as the first dielectric layer 111, and may correspond to, for example, a portion of the first dielectric layer 111. That is, the first side margin region 114′ and the second side margin region 115′ may include a ceramic material, for example, a barium titanate (BaTiO₃) ceramic material.

The multilayer electronic component 100 may include side margin portions 114 and 115 disposed on both end-surfaces of the third direction of the body 110.

More specifically, the side margin portions 114 and 115 may include a first side margin portion 114 disposed on the fifth surface 5 and a second side margin portion 115 disposed on the sixth surface 6 of the body 110.

The side margin portions 114 and 115 may be formed by forming the internal electrodes 121 and 122 by applying a conductive paste to a ceramic green sheet applied to the capacitance forming portion Ac, other than the region in which side margin portions 114 and 115 are formed, cutting the internal electrodes 121 and 122 after lamination to be exposed to the fifth and sixth surfaces 5 and 6 of the body 110 so as to suppress a step difference caused by the internal electrodes 121 and 122, and arranging or laminating a single third dielectric layer or two or more third dielectric layers in the third direction on both end-surfaces of the capacitance forming portion Ac.

The side margin portions 114 and 115 may prevent damages to the internal electrodes 121 and 122 due to physical or chemical stress.

The first side margin portion 114 and the second side margin portion 115 do not include the internal electrodes 121 and 122, and may include the same material as the dielectric layer 111. That is, the first side margin portion 114 and the second side margin portion 115 may include a ceramic material, for example, a barium titanate (BaTiO₃)-based ceramic material.

The width wm of the first and second side margin portions 114 and 115 may not be limited to any particular example, and hereinafter, the description of the widths wm of the side margin portions 114 and 115 may indicate the widths wm of the first side margin portion 114 and the second side margin portion 115, respectively.

However, to easily implement miniaturization and high capacitance of the multilayer electronic component 100, the width wm of the side margin portions 114 and 115 may be 100 μm or less, preferably 30 μm or less, and may be more preferably 20 μm or less in an ultra-small product.

Here, the width wm of the side margin portions 114 and 115 may refer to the size of the side margin portions 114 and 115 in the third direction.

Also, the width wm of the side margin portions 114 and 115 may refer to the average width wm of the side margin portions 114 and 115, and the average size in the third direction of the side margin portions 114 and 115.

The average size in the third direction of the side margin portion 114 and 115 may be measured by scanning a cross-section in the first and third directions of the body 110 using a scanning electron microscope (SEM) at a magnification of 10,000. More specifically, the average size may be an average value measured from the sizes in the third direction at 10 points at an equal distance in the first direction in the scanned image of one of the side margin portions.

In an embodiment, the multilayer electronic component 100 may have two external electrodes 131 and 132, but the number of the external electrodes 131 and 132 or the shape thereof may be varied depending on the forms of the internal electrodes 121 and 122 or other purposes.

The external electrodes 131 and 132 may be disposed on the body 110 and may be connected to the internal electrodes 121 and 122.

More specifically, the external electrodes 131 and 132 may be disposed on the third and fourth surfaces 3 and 4 of the body 110, respectively, and may include first and second external electrodes 131 and 132 connected to the first and second internal electrodes 121 and 122, respectively. That is, the first external electrode 131 may be disposed on the third surface 3 of the body and may be connected to the first internal electrode 121, and the second external electrode 132 may be disposed on the fourth surface 4 of the body and may be connected to the second internal electrode 122.

Also, the external electrodes 131 and 132 may extend and may be disposed on portions of the first and second surfaces 1 and 2 of the body 110, or may extend and be disposed on a portion of the fifth and sixth surfaces 5 and 6 of the body 110. That is, the first external electrode 131 may be disposed on a portion of the first, second, fifth, and sixth surfaces 1, 2, 5, and 6 of the body 110, and the third surface 3 of the body 110, and the second external electrode 132 may be disposed on a portion of the first, second, fifth, and sixth surfaces 1, 2, 5, and 6 of the body 110, and the third surface 3 of the body 110.

The external electrodes 131 and 132 may be formed of any material having electrical conductivity, such as metal, and a specific material may be determined in consideration of electrical properties and structural stability, and the external electrodes 131 and 132 may have a multilayer structure.

For example, the external electrodes 131 and 132 may include an electrode layer disposed on the body 110 and a plating layer disposed on the electrode layer. In this case, the electrode layer may include a first electrode layer disposed on the body and a second electrode layer disposed on the first electrode layer, and the plating layer may include a first plating layer disposed on the electrode layer and a second plating layer disposed on the first plating layer, but an embodiment thereof is not limited thereto. The electrode layer and plating layer will be described in greater detail below.

For a more specific example of the electrode layers 131a, 132a, 131b, and 132b, the electrode layers 131a, 132a, 131b, and 132b may include the first electrode layer 131a and 132a, which is a firing electrode including the first conductive metal and glass, or the second electrode layer 131b and 132b, which is a resin-based electrode including the second conductive metal and resin.

Here, the conductive metal included in the first electrode layers 131a and 132a may be referred to as the first conductive metal, and the conductive metal included in the second electrode layers 131b and 132b may be referred to as the second conductive metal. In this case, the first conductive metal and the second conductive metal may be the same or different from each other, and in the case in which a plurality of conductive metals are included, only a portion thereof may include the same conductive metal, but an embodiment thereof is not limited thereto.

Also, the electrode layers 131a, 132a, 131b, and 132b may be formed in a form in which the first electrode layers 131a and 132a, which are firing electrode layers, and the second electrode layers 131b and 132b, which are resin-based electrode layers, are formed in order on the body 110.

The electrode layers 131a, 132a, 131b, and 132b may be formed by transferring a sheet including a conductive metal onto the body, or may be formed by transferring a sheet including a conductive metal onto the firing electrode. Alternatively, the electrode layers may be formed by applying a conductive paste for an external electrode including a conductive metal to the body 110 and performing firing, or by dipping the body 110 into a conductive paste for an external electrode including a conductive metal, but an embodiment thereof is not limited thereto.

A material having excellent electrical conductivity may be used as the conductive metal included in the electrode layers 131a, 132a, 131b, and 132b, and for example, the conductive metal may include one or more selected from a group consisting of nickel (Ni), copper (Cu), palladium (Pd), silver (Ag), gold (Au), platinum (Pt), tin (Sn), tungsten (W), titanium (Ti), and alloys thereof, but an example embodiment thereof is not limited thereto.

In an embodiment, the electrode layers 131a, 132a, 131b, and 132b may have a two-layer structure including the first electrode layers 131a and 132a and the second electrode layers 131b and 132b, and more specifically, the external electrode 131, 132 may include the first electrode layers 131a and 132a including a first conductive metal and glass, and the second electrode layers 131b and 132b disposed on the first electrode layers 131a and 132a including a second conductive metal and resin.

The first electrode layers 131a and 132a may improve bonding with the body 110 by including glass, and the second electrode layers 131b and 132b may improve warpage strength by including resin.

The first conductive metal included in the first electrode layers 131a and 132a is not limited to any particular example as long as the material may be electrically connected to the internal electrodes 121 and 122 to form a capacitance, and for example, at least one of nickel (Ni), copper (Cu), palladium (Pd), silver (Ag), gold (Au), platinum (Pt), tin (Sn), tungsten (W), titanium (Ti) and alloys thereof may be included.

The first electrode layers 131a and 132a may be formed by applying a conductive paste prepared by adding a glass frit to first conductive metal particles and firing.

The second conductive metal included in the second electrode layers 131b and 132b may electrically connect to the first electrode layers 131a and 132a.

The second conductive metal included in the second electrode layers 131b and 132b is not limited to any particular example as long as the material may be electrically connected to the first electrode layers 131a and 132a, and at least one of nickel (Ni), copper (Cu), palladium (Pd), silver (Ag), gold (Au), platinum (Pt), tin (Sn), tungsten (W), titanium (Ti) and alloys thereof may be included.

The second conductive metal included in the second electrode layers 131b and 132b may include at least one of spherical particles and flake-shaped particles. That is, the second conductive metal may be composed of only flake-shaped particles, only spherical particles, or a mixed form of flake-shaped particles and spherical particles. Here, the spherical particles may include shapes not completely spherical, and for example, shapes having a length ratio of the major axis to the minor axis (major axis/minor axis) of 1.45 or less. The flake-shaped particles may refer to particles having a flat and elongated shape, and are not limited to any particular example thereto, and the flake-shaped particles may have, for example, a length ratio of the major axis to the minor axis (major axis/minor axis) of 1.95 or more. The lengths of the major and minor axes of the spherical particles and flake-shaped particles may be measured from images obtained by scanning a cross-section in the first and second directions taken from the center of the third direction of the multilayer electronic component using a scanning electron microscope (SEM).

The resin included in the second electrode layers 131b and 132b may assure bonding properties and absorbing impact, and is not limited to any particular example as long as the resin may be mixed with the second conductive metal particles to form a paste. For example, the resin may include epoxy resin.

Also, the second electrode layers 131b and 132b may further include an intermetallic compound.

By including the intermetallic compound, electrical connectivity with the first electrode layers 131a and 132a may be further improved. The intermetallic compound may improve electrical connectivity by connecting a plurality of second conductive metal particles, and may surround and connect the plurality of second conductive metal particles.

In this case, the intermetallic compound may include a metal having a melting point lower than a curing temperature of resin. That is, since the intermetallic compound includes a metal having a melting point lower than the curing temperature of the resin, the metal having a melting point lower than the curing temperature of the resin may be melted during a drying and curing process, and may form an intermetallic compound with a portion of the metal particle and may surround the metal particle. In this case, the intermetallic compound may preferably include a low melting point metal of 300° C. or less.

For example, Sn having a melting point of 213-220° C. may be included. During the drying and curing process, Sn may melt, and the melted Sn may wet high-melting point metal particles such as Ag, Ni, or Cu by capillary action, and may react with a portion of the Ag, Ni, or Cu metal particles and may form an intermetallic compound such as Ag₃Sn, Ni₃Sn₄, Cu₆Sn₅, and Cu₃Sn. Ag, Ni or Cu not participating in the reaction may remain in the form of metal particles.

Therefore, the plurality of second conductive metal particles may include one or more of Ag, Ni and Cu, and the intermetallic compound may include one or more of Ag₃Sn, Ni₃Sn₄, Cu₆Sn₅ and Cu₃Sn.

The plating layers 131c and 132c may improve mounting properties.

The types of plating layers 131c and 132c are not limited to any particular example, and may be plating layers 131c and 132c including one or more of nickel (Ni), tin (Sn), silver (Ag), palladium (Pd) and alloys thereof, or a plurality of plating layers 131c and 132c may be formed.

For a more specific example of the plating layers 131c and 132c, the plating layers 131c and 132c may be Ni plating layers or Sn plating layers, and the Ni plating layers and the Sn plating layers may be formed in order on the electrode layer, and the Sn plating layers, Ni plating layers and Sn plating layers may be formed in order. Also, the plating layers 131c and 132c may include a plurality of Ni plating layers and/or a plurality of Sn plating layers.

The size of the multilayer electronic component 100 may not be limited to any particular example.

However, to implement both miniaturization and high capacitance, the number of laminates may need to be increased by reducing the thickness of the dielectric layer and the internal electrode, such that the effect described in the embodiments may be noticeable in the multilayer electronic component 100 having a size 3216 (Length×Width: 3.2 mm×1.6 mm, the length and width satisfy the error within ±5%).

Hereinafter, the embodiments will be described in greater detail through the experimental example, which may be provided for understanding of the embodiments and the scope of embodiments is not limited thereto.

### EXPERIMENTAL EXAMPLE

Comparative example 1 was prepared in the form of a pellet by firing powder particles of barium titanate (BaTiO₃) material without a donor element and an acceptor element at a temperature of 1300° C. for 5 hours. In this case, additives including niobium (Nb) and magnesium (Mg) elements, such as niobium oxide (Nb₂O₅) and magnesium oxide (MgO), were not added.

Comparative example 2 used a material in which niobium oxide (Nb₂O₅) and magnesium oxide (MgO) were mixed with barium carbonate (BaCO₃) powder particles and titanium dioxide (TiO₂) powder particles, which are raw materials for barium titanate (BaTiO₃) material, and was prepared in the form of a pellet under the same firing conditions as comparative example 1, and the firing conditions were controlled such that core-shell dielectric grains were not formed. In this case, 1 mole of niobium oxide (Nb₂O₅) and 1 mole of magnesium oxide (MgO) were added based on 100 moles of titanium dioxide (TiO₂), and in terms of elements, 2 moles of niobium (Nb) and 1 mole of magnesium (Mg) were added based on 100 moles of titanium (Ti).

Embodiment 1 used a material in which powder particles of barium titanate (BaTiO₃) material is mixed with niobium oxide (Nb₂O₅) and magnesium oxide (MgO), and was prepared in the form of a pellet using the same method as comparative example 1, and the firing conditions were controlled such that core-shell dielectric grains were formed. In this case, 0.5 moles of niobium oxide (Nb₂O₅) and 0.5 moles of magnesium oxide (MgO) were added based on 100 moles of barium titanate (BaTiO₃), and in terms of elements, 1 mole of niobium (Nb) and 0.5 moles of magnesium (Mg) were added based on 100 moles of titanium (Ti).

Embodiment 2 used a material in which powder particles of barium titanate (BaTiO₃) material is mixed with niobium oxide (Nb₂O₅) and magnesium oxide (MgO), and was prepared in the form of a pellet in the same manner as comparative example 1, and the firing conditions were controlled such that core-shell dielectric grains were formed. In this case, 1 mole of niobium oxide (Nb₂O₅) and 1 mole of magnesium oxide (MgO) were added based on 100 moles of barium titanate (BaTiO₃), and in terms of elements, 2 moles of niobium (Nb) and 1 mole of magnesium (Mg) were added based on 100 moles of titanium (Ti).

Embodiment 3 used a material in which powder particles of barium titanate (BaTiO₃) material is mixed with niobium oxide (Nb₂O₅) and magnesium oxide (MgO), and was prepared in the form of a pellet in the same manner as comparative example 1, and the firing conditions were controlled such that core-shell dielectric grains were formed. In this case, 2 moles of niobium oxide (Nb₂O₅) and 2 moles of magnesium oxide (MgO) were added based on 100 moles of barium titanate (BaTiO₃), and in terms of elements, 4 moles of niobium (Nb) and 2 moles of magnesium (Mg) were added based on 100 moles of titanium (Ti).

In the [Table 1] below, the main component indicates that barium titanate (BaTiO₃) was used as a dielectric material, and the sub-component indicates the added content based on 100 moles of the main component BaTiO₃.

The core-shell may indicate the presence or absence of core-shell dielectric grains in which niobium (Nb) and magnesium (Mg) are detected only in the shell and not in the core during TEM-EDS analysis.

For dielectric constant measurement, Ag paste was applied to the upper and lower surfaces of each fired pellet, and after curing, the two Ag electrodes were contacted with an LCR meter (or impedance analyzer). The dielectric constant was obtained by considering and converting the electric capacitance value obtained using the LCR meter (or impedance analyzer) into the pellet thickness and the area structure of the electrode. The conditions of 1 V (applied AC voltage) and 1 kHz (measurement frequency) were used for electric capacitance measurement, but the same evaluation may be performed with other dielectric constant measurement equipment and conditions.

DF (%) may indicate a dissipation factor and was measured with the same equipment and the method as in the dielectric constant measurement.

Resistivity (Ω cm) was obtained by contacting the two Ag electrodes of the pellet prepared in the same manner as the dielectric constant measurement with a multimeter, and converting the measured resistance value into the pellet thickness and the area structure of the electrode.

TABLE 1

| | Main | Sub- | Core- | Dielectric | DF | Resistivity |
|---|---|---|---|---|---|---|
| Sample | component | component | shell | constant | (%) | (Ω · cm) |
| Comparative | BaTiO₃ | Nb 0 mol | X | 4.1 × 10³ | 2.6% | 1.5 × 10¹² |
| example 1 | | Mg 0 mol | | | | |
| Comparative | BaTiO₃ | Nb 2 mol | X | 2.3 × 10⁴ | 17.5% | <10⁵ |
| example 2 | | Mg 1 mol | | | | |
| Embodiment 1 | BaTiO₃ | Nb 1 mol | ◯ | 1.6 × 10⁴ | 10.0% | 1.2 × 10¹⁰ |
| | | Mg 0.5 mol | | | | |
| Embodiment 2 | BaTiO₃ | Nb 2 mol | ◯ | 8.8 × 10³ | 7.0% | 8.2 × 10¹⁰ |
| | | Mg 1 mol | | | | |
| Embodiment 3 | BaTiO₃ | Nb 4 mol | ◯ | 1.1 × 10⁴ | 8.2% | 3.0 × 10¹⁰ |
| | | Mg 2 mol | | | | |

In comparative example 1, the core-shell dielectric grain was not detected by TEM-EDS analysis, the dissipation factor DF was low at 2.6%, and resistivity was also high at 1.5×10¹² Ω·cm, but the dielectric constant was relatively low, 4.1×10³.

In comparative example 2, as the result of the TEM-EDS analysis niobium (Nb) and magnesium (Mg) were detected throughout the dielectric grain, and the core-shell dielectric grain was not observed. The dielectric constant was relatively high, 2.3×10⁴, but the dissipation factor DF was relatively high, 17.5%, and resistivity was also relatively low, less than 10⁵ Ω·cm.

In embodiment 1, core-shell dielectric grains were observed as a result of TEM-EDS analysis. In the core, niobium (Nb) was 0.59 at % and magnesium (Mg) was 0.58 at % based on 100 at % titanium (Ti), and in the shell, niobium (Nb) was 3.06 at % and magnesium (Mg) was 1.55 at % based on 100 at % titanium (Ti). The dielectric constant was relatively high, 1.6×10⁴, the dissipation factor DF was relatively low, 10.0%, and resistivity was also relatively high, 1.2×10¹⁰ Ω·cm.

In embodiment 2, as a result of TEM-EDS analysis, core-shell dielectric grains were observed. In the core, niobium (Nb) was 0.59 at % and magnesium (Mg) was 0.58 at % based on 100 at % titanium (Ti), and in the shell, niobium (Nb) was 6.63 at % and magnesium (Mg) was 3.23 at % based on 100 at % titanium (Ti). The dielectric constant was relatively high, 8.8×10³, the dissipation factor DF was relatively low, 7.0%, and resistivity was also relatively high, 8.2×10¹⁰ Ω·cm.

In embodiment 3, as a result of the TEM-EDS analysis, core-shell dielectric grains were observed. In the core, niobium (Nb) was 0.59 at % and magnesium (Mg) was 0.59 at % based on 100 at % titanium (Ti), and in the shell, niobium (Nb) was 12.92 at % and magnesium (Mg) was 6.53 at % based on 100 at % titanium (Ti). The dielectric constant was relatively high, 1.1×10⁴, the dissipation factor DF was relatively low, 8.2%, and resistivity was also relatively high, 3.0×10¹⁰ Ω·cm.

Accordingly, it is indicated that, when the dielectric layer includes a core-shell dielectric grain, and the donor element including niobium (Nb) was 2 at % or more and 13 at % or less based on 100 at % of titanium (Ti) in the shell, and the acceptor element including magnesium (Mg) was 1 at % or more and 13 at % or less, the dielectric constant, dissipation factor DF, and resistivity properties were excellent.

According the to aforementioned embodiments, dielectric properties and resistivity properties of a multilayer electronic component may be improved.

The embodiments do not necessarily limit the scope of the embodiments to a specific embodiment form. Instead, modifications, equivalents and replacements included in the disclosed concept and technical scope of this description may be employed. Throughout the specification, similar reference numerals are used for similar elements.

In the embodiments, the term “embodiment” may not refer to one same embodiment, and may be provided to describe and emphasize different unique features of each embodiment. The suggested embodiments may be implemented do not exclude the possibilities of combination with features of other embodiments. For example, even though the features described in an embodiment are not described in the other embodiment, the description may be understood as relevant to the other embodiment unless otherwise indicated.

Terms used in the present specification are for explaining the embodiments rather than limiting the embodiments. Unless explicitly described to the contrary, a singular form may include a plural form in the present specification

While the embodiments have been illustrated and described above, it will be configured as apparent to those skilled in the art that modifications and variations could be made without departing from the scope of the present disclosure as defined by the appended claims.

What is claimed is:

1. A multilayer electronic component, comprising:
a body including a dielectric layer and internal electrodes; and
external electrodes disposed on the body,
wherein the dielectric layer includes a core-shell dielectric grain including:
a core that is free of a donor element and an acceptor element, and
a shell covering at least a portion of the core and including the donor element, the acceptor element, and titanium (Ti), and
wherein, when an atomic percentage of the donor element included in the shell is defined as Ds and an atomic percentage of the acceptor element included in the shell is defined as As, based on an atomic percentage of 100 at % of titanium (Ti) included in the shell, 2 at %≤Ds≤13 at % and 1 at %≤As≤13 at % are satisfied.

2. The multilayer electronic component of claim 1, wherein Ds and As satisfy As≤Ds.

3. The multilayer electronic component of claim 2, wherein Ds and As satisfy As≤Ds≤3×As.

4. The multilayer electronic component of claim 1, wherein, when a number of moles of the donor element based on 100 parts by mole of titanium (Ti) included in the dielectric layer is defined as Dm, and a number of moles of the acceptor element based on 100 parts by mole of titanium (Ti) included in the dielectric layer is defined as Am, 0.5 part by mole≤Dm≤4 parts by mole and 0.25 part by mole≤Am≤4 parts by mole are satisfied.

5. The multilayer electronic component of claim 1, wherein, when a number of moles of the donor element based on 100 parts by mole of titanium (Ti) included in the dielectric layer is defined as Dm, and a number of moles of the acceptor element based on 100 parts by mole of titanium (Ti) included in the dielectric layer is defined as Am, Am≤Dm is satisfied.

6. The multilayer electronic component of claim 5, wherein Dm and Am satisfy Am≤Dm≤3×Am.

7. The multilayer electronic component of claim 1,
wherein the dielectric layer includes a main component selected from barium titanate (BaTiO₃) and strontium titanate (SrTiO₃), and
wherein the shell includes a substituted main component in which at least one of element sites other than an oxygen element (O) of the main component is substituted by at least one selected from the donor element and the acceptor element.

8. The multilayer electronic component of claim 1,
wherein the donor element: includes at least one selected from niobium (Nb), tantalum (Ta), and vanadium (V), and the acceptor element includes at least one selected from aluminum (Al), gallium (Ga), magnesium (Mg), zinc (Zn), scandium (Sc), indium (In), ytterbium (Yb), erbium (Er), and europium (Eu).

9. A multilayer electronic component, comprising:
a body including a dielectric layer including titanium (Ti), and internal electrodes; and
external electrodes disposed on the body,
wherein the dielectric layer includes a core-shell dielectric grain including:
a core that is free of a donor element and an acceptor element, and
a shell covering at least a portion of the core and including the donor element, and the acceptor element, and
wherein, when a number of moles of the donor element based on 100 parts by mole of titanium (Ti) included in the dielectric layer is defined as Dm, and a number of moles of the acceptor element based on 100 parts by mole of titanium (Ti) included in the dielectric layer is defined as Am, 0.5 part by mole≤Dm≤4 parts by mole and 0.25 part by mole≤Am≤4 parts by mole are satisfied.

10. The multilayer electronic component of claim 9, wherein Dm and Am satisfy Am≤Dm.

11. The multilayer electronic component of claim 10, wherein Dm and Am satisfy Am≤Dm≤3×Am.

12. The multilayer electronic component of claim 9,
wherein the shell includes titanium (Ti), and
wherein, when an atomic percentage of the donor element included in the shell is defined as Ds, and an atomic percentage of the acceptor element included in the shell is defined as As, based on an atomic percentage of 100 at % of titanium (Ti) included in the shell, As≤Ds is satisfied.

13. The multilayer electronic component of claim 12, wherein Ds and As satisfy As≤Ds≤3×As.

14. The multilayer electronic component of claim 12, wherein Ds and As satisfy 2 at %≤Ds≤13 at % and 1 at %≤As ≤13 at %.

15. The multilayer electronic component of claim 9,
wherein the dielectric layer includes a main component selected from barium titanate (BaTiO₃) and strontium titanate (SrTiO₃), and
wherein the shell includes a substituted main component in which at least one of element sites other than an oxygen element (O) of the main component is substituted by at least one selected from the donor element and the acceptor element.

16. The multilayer electronic component of claim 9, wherein the donor element includes at least one selected from niobium (Nb), tantalum (Ta), and vanadium (V), and the acceptor element includes at least one selected from aluminum (Al), gallium (Ga), magnesium (Mg), zinc (Zn), scandium (Sc), indium (In), ytterbium (Yb), erbium (Er), and europium (Eu).

17. The multilayer electronic component of claim 9, wherein the donor element includes niobium (Nb).

18. The multilayer electronic component of claim 9,
wherein the acceptor element includes magnesium (Mg).

19. The multilayer electronic component of claim 9, wherein the dielectric layer includes a main component that includes barium titanate (BaTiO₃).
